(19) United States
(12) Patent Application Publication
(10) Pub. No.: US 2024/0425705 A1
(43) Pub. Date: Dec. 26, 2024

(54) PHOTOCURABLE RESIN COMPOSITION FOR THREE-DIMENSIONAL FABRICATION AND METHOD FOR PRODUCING THREE-DIMENSIONAL OBJECTS

(71) Applicant: CANON KABUSHIKI KAISHA, Tokyo (JP)

(72) Inventor: CHIAKI NISHIURA, Tokyo (JP)

(21) Appl. No.: 18/747,804

(22) Filed: Jun. 19, 2024

(30) Foreign Application Priority Data
Jun. 20, 2023 (JP) 2023-100876
May 15, 2024 (JP) 2024-079334

(51) Int. Cl. C09D 4/00; B29C 64/129; B29K 33/00; B29K 55/00; B29K 67/00; B29K 69/00; B29K 71/00; B29K 75/00; B29K 79/00; B29K 105/16; B33Y 70/00; C09D 7/65

(52) U.S. Cl. CPC C09D 4/00; B33Y 70/00; C09D 7/65; B29C 64/129; B29K 2033/00; B29K 2033/26; B29K 2055/00; B29K 2067/00; B29K 2069/00; B29K 2071/00; B29K 2075/00; B29K 2079/085; B29K 2105/16; B29K 2995/0094

(57) ABSTRACT

A photocurable resin composition contains a radically polymerizable compound (A), polysilsesquioxane particles (B), and a curing agent (C). Polysilsesquioxane particles (B) have polysilsesquioxane at least at the surface of the particles. The radically polymerizable compound (A) is a mixture of multifunctional radically polymerizable compound (A-1) and monofunctional radically polymerizable compound (A-2), including at least multifunctional radically polymerizable compound (A-1) in more than 60% by mass. Multifunctional radically polymerizable compound (A-1) has an ethylenically unsaturated group equivalent of 250 g/eq to less than 700 g/eq. The amount of polysilsesquioxane particles (B) is 5 to 30 parts by mass relative to 100 parts by mass of radically polymerizable compound (A).

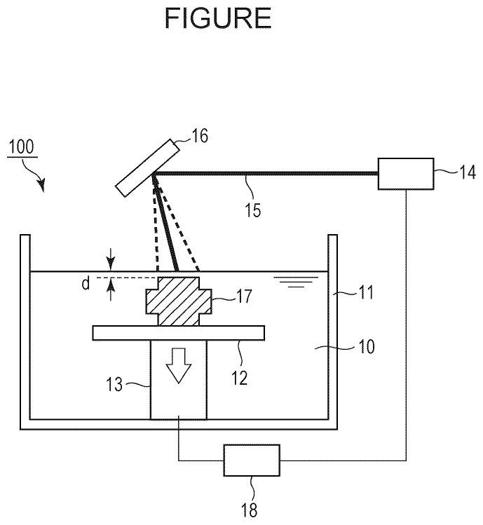

### BACKGROUND

### Field

The present disclosure relates to a photocurable resin composition for three-dimensional fabrication and a method for manufacturing three-dimensional objects.

### Description of the Related Art

Three-dimensional optical fabrication (stereolithography), in which a desired three-dimensional object is manufactured by curing a photocurable resin composition layer by layer using light, such as ultraviolet light and stacking the layers one after another, is under intensive study as an application of liquid curable resin compositions. Stereolithography enables fabrication with higher precision than other methods, and its applications have been expanding beyond prototype fabrication for shape check (rapid prototyping) to working model fabrication for functionality check and mold fabrication (rapid tooling). Furthermore, the applications are expanding to actual product fabrication (rapid manufacturing).

Accordingly, sophisticated curable resin compositions are increasingly desired. For example, there is desired a curable resin composition that can form articles having sliding properties with a low friction coefficient and high wear resistance and mechanical properties with high rigidity and heat resistance, like general-purpose engineering plastics.

Japanese Patent Laid-Open No. 2017-165964 discloses an energy beam-curable composition containing non-polymerizable resin and a multifunctional radically polymerizable acrylate to achieve high scratch resistance.

Shaped objects used as merchandise are desired to have high heat resistance, as well as a low friction coefficient and high wear resistance (these two properties are referred to as “sliding properties”). The expression “high sliding properties” or “excellent sliding properties” used herein means having both a low friction coefficient and high wear resistance. However, it is not easy to satisfy these physical properties at once.

Japanese Patent Laid-Open No. 2017-165964 has achieved wear resistance that is not scratched by rubbing the surface of coatings with a cotton swab but does not take friction coefficient or heat resistance into account, not disclosing any of these properties.

### SUMMARY

Accordingly, the present disclosure provides a photocurable resin composition for three-dimensional fabrication, enabling the fabrication of articles with excellent heat resistance and sliding properties.

A photocurable resin composition disclosed herein for three-dimensional fabrication contains a radically polymerizable compound (A), polysilsesquioxane particles (B), and a curing agent (C). Polysilsesquioxane particles (B) have polysilsesquioxane at least at the surfaces thereof. The radically polymerizable compound (A) includes at least multifunctional radically polymerizable compound (A-1) in more than 60% by mass. The multifunctional radically polymerizable compound (A-1) has an ethylenically unsaturated group equivalent of 250 g/eq to less than 700 g/eq. The polysilsesquioxane particles (B) are in a proportion of 5 to 30 parts by mass relative to 100 parts by mass of the radically polymerizable compound (A).

Also, the present disclosure provides a cured product produced by curing the photocurable resin composition.

Furthermore, the present disclosure provides a method for producing three-dimensional objects using stereolithography. The method includes: forming a layer of the above-described photocurable resin composition; and irradiating the layer of the photocurable resin composition with light energy to cure the layer according to slice data of a fabrication model.

Further features of the present disclosure will become apparent from the following description of exemplary embodiments with reference to the attached drawing.

### BRIEF DESCRIPTION OF THE DRAWINGS

Figure depicts a configuration of a stereolithography apparatus.

### DESCRIPTION OF THE EMBODIMENTS

Some embodiments of the present disclosure will now be described. The following embodiments are only exemplary implementations of the disclosure and do not limit the disclosure.

In the description disclosed herein, good heat resistance implies that the sample exhibits a deflection temperature under load of 85° C. or higher when measured according to JIS K 7191, and excellent heat resistance implies that the sample exhibits a deflection temperature under load of 95° C. or higher. If the deflection temperature under load of the specimen is less than 85° C., the shaped object may be deformed at high temperatures. Particularly when the shaped object is used as a sliding portion, the frictional heat raises temperature beyond the softening point of the cured product defining the shaped object, resulting in an increased friction coefficient and decreased wear resistance.

The photocurable resin composition for three-dimensional fabrication (hereinafter also referred to as the curable resin composition or resin composition) disclosed herein contains a radically polymerizable compound (A), polysilsesquioxane particles (B), and a curing agent (C). The radically polymerizable compound (A) includes at least multifunctional radically polymerizable compound (A-1). In some embodiments, the radically polymerizable compound (A) is a mixture of multifunctional radically polymerizable compound (A-1) and monofunctional radically polymerizable compound (A-2). The constituents of the resin composition will now be described in detail. Multifunctional Radically Polymerizable Compound (A-1)

Multifunctional radically polymerizable compound (A-1) contained in the photocurable resin composition disclosed herein contains at least two radically polymerizable functional groups in the molecule. For example, ethylenically unsaturated groups are an example of the radically polymerizable functional group. Examples of ethylenically unsaturated groups include (meth)acryloyl and vinyl groups. Examples of multifunctional radically polymerizable compounds include (meth)acrylate-based compounds, vinyl ether group-containing (meth)acrylate-based compounds, (meth)acryloyl group-containing isocyanurate-based compounds, (meth)acrylamide-based compounds, urethane (meth)acrylate-based compounds, maleimide-based compounds, vinyl ether-based compounds, aromatic vinyl-based compounds, epoxy acrylates, and polyester acrylates. Among these, (meth)acrylate-based or urethane (meth)acrylate-based compounds may be used from the viewpoint of availability and curability.

In some embodiments, urethane (meth)acrylate-based compounds, which have urethane structures, are selected as multifunctional radically polymerizable compound (A-1). Urethane (meth)acrylate-based compounds are easy to synthesize and available, and their shaped objects have high toughness and heat resistance.

Multifunctional radically polymerizable compounds with a polyether structure are also favorable because they have low viscosity and good fluid cut-off during fabrication, and their shaped objects are highly precise. Also, multifunctional radically polymerizable compounds with a polyether or polycarbonate structure are favorable because they can lead to shaped objects with high toughness and heat resistance.

Therefore, in some embodiments, multifunctional radically polymerizable compound (A-1) is one or more (meth)acrylate-based or urethane (meth)acrylate-based compounds having a polyether structure, a polyester structure, or a polycarbonate structure.

multifunctional Radically polymerizable compound (A-1) may be an individual compound or a combination of the above-cited multifunctional radically polymerizable compounds. Multifunctional radically polymerizable compound (A-1) used herein is a collective term for one or more multifunctional radically polymerizable compounds contained in the photocurable resin composition.

Multifunctional radically polymerizable compounds having a urethane structure may be obtained by a reaction of, for example, a hydroxy group-containing (meth)acrylate-based compound and a multivalent isocyanate-based compound. Also, they may be obtained by a reaction of, for example, a hydroxy group-containing (meth)acrylate-based compound, a multivalent isocyanate-based compound, and a polyol. From the viewpoint of obtaining high toughness, compounds obtained by a reaction of a hydroxy group-containing (meth)acrylate-based compound, a multivalent isocyanate-based compound, and a polyol may be used.

Examples of hydroxy group-containing (meth)acrylate-based compounds include hydroxyalkyl (meth)acrylates, such as 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate; and 2-hydroxyethyl acryloyl phosphate, 2-(meth)acryloyloxyethyl-2-hydroxypropyl phthalate, caprolactone-modified 2-hydroxyethyl (meth)acrylate, dipropylene glycol (meth)acrylate, fatty acid-modified-glycidyl (meth)acrylate, polyethylene glycol mono(meth)acrylate, polypropylene glycol mono(meth)acrylate, 2-hydroxy-3-(meth)acryloyloxypropyl (meth)acrylate, glycerol di(meth)acrylate, 2-hydroxy-3-acryloyloxypropyl methacrylate, pentaerythritol tri(meth)acrylate, caprolactone-modified pentaerythritol tri(meth)acrylate, ethylene oxide-modified pentaerythritol tri(meth)acrylate, dipentaerythritol penta(meth)acrylate, caprolactone-modified dipentaerythritol penta(meth)acrylate, and ethylene oxide-modified dipentaerythritol penta(meth)acrylate. These hydroxy group-containing (meth)acrylate-based compounds may be used individually or in combination.

Examples of multivalent isocyanate-based compounds include aromatic polyisocyanates, such as tolylene diisocyanate, diphenylmethane diisocyanate, polyphenylmethane polyisocyanate, modified diphenylmethane diisocyanate, xylylene diisocyanate, tetramethylxylylene diisocyanate, phenylene diisocyanate, and naphthalene diisocyanate; aliphatic polyisocyanates, such as pentamethylene diisocyanate, hexamethylene diisocyanate, trimethylhexamethylene diisocyanate, lysine diisocyanate, and lysine triisocyanate; alicyclic polyisocyanates, such as hydrogenated diphenylmethane diisocyanate, hydrogenated xylylene diisocyanate, isophorone diisocyanate, norbornene diisocyanate, and 1,3-bis(isocyanatomethyl)cyclohexane; trimers or multimers of the above polyisocyanates; and allophanate-containing polyisocyanates, biuret-containing polyisocyanates, and water-dispersible polyisocyanates. These multivalent isocyanate-based compounds may be used individually or in combination.

Examples of polyols include polyether-based polyols, polyester-based polyols, polycarbonate-based polyols, polyolefin-based polyols, polybutadiene-based polyols, (meth)acrylic polyols, and polysiloxane-based polyols. These polyols may be used individually or in combination.

Example of polyether-based polyols include alkylene structure-containing polyether-based polyols, such as polyethylene glycol, polypropylene glycol, polytetramethylene glycol, polybutylene glycol, and polyhexamethylene glycol, and random or block copolymers of these polyalkylene glycols.

Examples of polyester-based polyols include condensation polymers of polyhydric alcohols and multivalent carboxylic acids, ring-opening polymerization products of cyclic esters (lactones), and reaction products of three components: polyhydric alcohols, multivalent carboxylic acids, and cyclic esters.

Examples of polyhydric alcohols include ethylene glycol, diethylene glycol, propylene glycol, dipropylene glycol, trimethylene glycol, 1,4-tetramethylenediol, 1,3-tetramethylenediol, 2-methyl-1,3-trimethylenediol, 1,5-pentamethylenediol, neopentylglycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (e.g., 1,4-cyclohexanediol), bisphenols (e.g., bisphenol A), and sugar alcohols (e.g., xylitol and sorbitol).

Examples of multivalent carboxylic acids include aliphatic dicarboxylic acids, such as malonic acid, maleic acid, fumaric acid, succinic acid, glutaric acid, adipic acid, suberic acid, azelaic acid, sebacic acid, and dodecanedioic acid; alicyclic dicarboxylic acids, such as 1,4-cyclohexanedicarboxylic acid; and aromatic dicarboxylic acids, such as terephthalic acid, isophthalic acid, orthophthalic acid, 2,6-naphthalenedicarboxylic acid, para-phenylenedicarboxylic acid, and trimellitic acid.

Examples of cyclic esters include propiolactone, β-methyl-δ-valerolactone, and ε-caprolactone.

Examples of polycarbonate-based polyols include reaction products of a polyhydric alcohol and phosgene and ring-opening polymerization products of cyclic carbonate esters (e.g., alkylene carbonates).

The polyhydric alcohol may be selected from the polyhydric alcohols cited as the polyester-based polyols. Examples of alkylene carbonates include ethylene carbonate, trimethylene carbonate, tetramethylene carbonate, and hexamethylene carbonate.

Polycarbonate-based polyols contain carbonate bonds and, at the ends, hydroxy groups and may contain an ester bond in addition to the carbonate bonds.

Multifunctional radically polymerizable compound (A-1) having a polyether, polyester, or polycarbonate structure may be obtained by a reaction of, for example, a polyether-based polyol, polyester-based polyol, or polycarbonate-based polyol with (meth)acryloyl chloride or (meth)acryloyl bromide.

Multifunctional radically polymerizable compound (A-1) contained in the photocurable resin composition disclosed herein has an ethylenically unsaturated group equivalent of 250 g/eq to less than 700 g/eq. When multifunctional radically polymerizable compound (A-1) contained in the photocurable resin composition is an individual multifunctional radically polymerizable compound, the ethylenically unsaturated group equivalent of the multifunctional radically polymerizable compound is from 250 g/eq to less than 700 g/eq. The term ethylenically unsaturated group equivalent mentioned here is the value obtained by dividing the weight average molecular weight (Mw) of the multifunctional radical polymerizable compound by the number of ethylenically unsaturated groups in the molecule. The smaller the ethylenically unsaturated group equivalent, the larger the crosslink density of the photo-cured product and the more heat-resistant the shaped object (article) can be. When multifunctional radically polymerizable compound (A-1) is a combination of a plurality of multifunctional radically polymerizable compounds, the ethylenically unsaturated group equivalent of multifunctional radically polymerizable compound (A-1) is the weighted average by mass of the ethylenically unsaturated group equivalents of the multifunctional radically polymerizable compounds constituting multifunctional radically polymerizable compound (A-1). Thus, the plurality of multifunctional radically polymerizable compounds are mixed so that their weighted average is 250 g/eq to less 700 g/eq. When multifunctional radically polymerizable compound (A-1) is a combination of a plurality of multifunctional radically polymerizable compounds, it may be a mixture of one or more multifunctional radically polymerizable compounds with an ethylenically unsaturated group equivalent of 250 g/eq to less than 700 g/eq and one or more multifunctional radically polymerizable compounds with an ethylenically unsaturated group equivalent of 700 g/eq or more.

The smaller the ethylenically unsaturated group equivalent of multifunctional radically polymerizable compound (A-1), the more heat-resistant the shaped object can be, but the higher the crosslink density of the resin composition after being photo-cured. When crosslink density is excessively high, the toughness of the shaped object decreases significantly, and the shaped object may be damaged when the support member is removed from the shaped object. Also, the shaped object may be damaged when fitted into another member or subjected to secondary work. The support member is a portion prepared to hold the intended shape during fabrication and is generally removed after the fabrication.

The larger the ethylenically unsaturated group equivalent of the multifunctional radically polymerizable compound (A-1), the smaller the crosslink density of the resin composition after being photo-cured, but the heat resistance decreases. Shaped objects with poor heat resistance may be deformed or deteriorate in sliding properties when used as sliding members, which are subject to frictional heat and softened.

Thus, from the viewpoint of obtaining a good balance of heat resistance, toughness, and formability, the ethylenically unsaturated group equivalent of multifunctional radically polymerizable compound (A-1) is from 250 g/eq to less than 700 g/eq and, in some embodiments, from 400 g/eq to less 700 g/eq from the viewpoint of easily removing the support member from the resulting shaped object.

The weight average molecular weight (Mw) of multifunctional radically polymerizable compound (A-1) is that in terms of standard polystyrene molecular weight. The weight average molecular weight can be measured by high-performance liquid chromatography using HLC-8220 GPC system (manufactured by Tosoh Corporation) with two Shodex GPCLF-804 columns (exclusion limit molecular weight: 2×10⁶, separation range: 300 to 2×10⁶) connected in series.

As long as radically polymerizable compound (A) in the photocurable resin composition includes multifunctional radically polymerizable compound (A-1) in more than 60% by mass, the photocurable resin composition exhibits sufficient curability and imparts sufficient heat resistance to the resulting shaped object. In other words, the amount of multifunctional radically polymerizable compound (A-1) can be more than 60% to 100% by mass to radically polymerizable compound (A).

In some embodiments, radically polymerizable compound (A) is a mixture containing multifunctional radically polymerizable compound (A-1) and monofunctional radically polymerizable compound (A-2). In this instance, the proportion of monofunctional radically polymerizable compound (A-2) may be from 5 to less than 40 parts by mass relative to 100 parts by mass in total of multifunctional radically polymerizable compound (A-1) and monofunctional radically polymerizable compound (A-2). When monofunctional radically polymerizable compound (A-2) is in a proportion of 5 parts by mass or more, the photocurable resin composition can maintain an appropriate viscosity and be suitably used for three-dimensional fabrication. Also, when monofunctional radically polymerizable compound (A-2) is in a proportion of less than 25 parts by mass, shaped objects obtained by curing the photocurable resin composition can keep the heat resistance high. Thus, the proportion of monofunctional radically polymerizable compound (A-2) is from 5 to less than 40 parts by mass relative to 100 parts by mass in total of multifunctional radically polymerizable compound (A-1) and monofunctional radically polymerizable compound (A-2) and may be, in some embodiments, from 5 to less than 25 parts by mass.

### Monofunctional Radically Polymerizable Compound (A-2)

Monofunctional radically polymerizable compound (A-2) optionally included in radically polymerizable compound (A) has a single radically polymerizable functional group in the molecule. As described above, monofunctional radically polymerizable compound (A-2) can impart a viscosity suitable for three-dimensional fabrication to the photocurable resin composition. Also, by adjusting the amount of monofunctional radically polymerizable compound (A-2) or selecting an appropriate monofunctional radically polymerizable compound, the mechanical properties of the shaped object obtained by curing the photocurable resin composition can be controlled in a desired range.

Examples of monofunctional radically polymerizable compound (A-2) include, but are not limited to, acrylamide-based compounds, (meth)acrylate-based compounds, maleimide-based compounds, styrene-based compounds, acrylonitrile-based compounds, vinyl esters-based compounds, N-vinyl compounds, conjugated dienes, vinyl ketones, vinyl halides, and vinylidene halides. In particular, acrylamide-based compounds, maleimide-based monomers, and N-vinyl compounds can impart curability to the resin composition and excellent heat resistance to the resulting shaped object.

Examples of acrylamide-based compounds include (meth)acrylamide, N-methyl (meth)acrylamide, N-isopropyl (meth)acrylamide, N-t-butyl (meth)acrylamide, N-phenyl (meth)acrylamide, N-methylol (meth)acrylamide, N,N-diacetone (meth)acrylamide, N,N-dimethyl (meth)acrylamide, N,N-diethyl(meth)acrylamide, N,N-dipropyl (meth)acrylamide, N,N-dibutyl(meth)acrylamide, N-(meth)acryloylmorpholine, N-(meth)acryloyl piperidine, N-[3-(dimethylamino)propyl]acrylamide, and N-t-octyl(meth)acrylamide.

Examples of (meth)acrylate-based compounds include methyl (meth)acrylate, ethyl (meth)acrylate, n-butyl (meth)acrylate, isobutyl (meth)acrylate, t-butyl (meth)acrylate, 2-ethylhexyl (meth)acrylate, n-octyl (meth)acrylate, i-octyl(meth)acrylate, lauryl (meth)acrylate, stearyl (meth)acrylate, cyclohexyl (meth)acrylate, isobornyl (meth)acrylate, adamantyl (meth)acrylate, 3-hydroxy-1-adamantyl (meth)acrylate, 3,5-dihydroxy-1-adamantyl (meth)acrylate, 2-methyl-2-adamantyl (meth)acrylate, 2-ethyl-2-adamantyl (meth)acrylate, 2-isopropyl-2-adamantyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, 3-methyl-3-oxetanylmethyl (meth)acrylate, tetrahydrofurfuryl (meth)acrylate, phenylglycidyl (meth)acrylate, dimethylaminomethyl (meth)acrylate, phenyl cellosolve (meth)acrylate, dicyclopentenyl (meth)acrylate, dicyclopentenyloxyethyl (meth)acrylate, biphenyl (meth)acrylate, 2-hydroxyethyl (meth)acryloyl phosphate, phenyl (meth)acrylate, phenoxyethyl (meth)acrylate, phenoxypropyl (meth)acrylate, benzyl (meth)acrylate, butoxy triethylene glycol (meth)acrylate, 2-ethylhexyl polyethylene glycol (meth)acrylate, nonylphenyl polypropylene glycol (meth)acrylate, methoxy dipropylene glycol (meth)acrylate, glycerol (meth)acrylate, trifluoromethyl (meth)acrylate, trifluoroethyl (meth)acrylate, tetrafluoropropyl (meth)acrylate, octafluoropentyl acrylate, polyethylene glycol (meth)acrylate, polypropylene glycol (meth)acrylate, allyl (meth)acrylate, 2,2,2-trifluoroethyl (meth)acrylate, 2,2,3,3-tetrafluoropropyl (meth)acrylate, 1H,1H,5H-octafluoropentyl (meth)acrylate, epichlorohydrin-modified butyl (meth)acrylate, epichlorohydrin-modified phenoxy (meth)acrylate, ethylene oxide (EO)-modified phthalic acid (meth)acrylate, EO-modified succinic acid (meth)acrylate, caprolactone-modified 2-hydroxyethyl (meth)acrylate, N,N-dimethylaminoethyl (meth)acrylate, N,N-diethylaminoethyl (meth)acrylate, morpholino (meth)acrylate, EO-modified phosphoric acid (meth)acrylate, 2-(allyloxymethyl)acrylic acid methyl ester (trade name: AO-MA, produced by Nippon Shokubai), imide group-containing (meth)acrylate (trade name: M-140, produced by Toagosei), and monofunctional (meth)acrylates with a siloxane structure.

Examples of maleimide-based compounds include maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

Examples of N-vinyl compounds include N-vinylpyrrolidone, N-vinylcaprolactam, N-vinylimidazole, N-vinylmorpholine, and N-vinylacetamide.

Other monofunctional radically polymerizable compounds include, for example, styrene and styrene derivatives, such as vinyltoluene, α-methylstyrene, chlorostyrene, and styrenesulfonic acid and its salts; vinyl esters, such as vinyl acetate, vinyl propionate, vinyl pivalate, vinyl benzoate, and vinyl cinnamate; and vinyl cyanide-based compounds, such as (meth)acrylonitrile.

These monofunctional radically polymerizable compounds may be used individually or in combination.

### Polysilsesquioxane Particles (B)

Polysilsesquioxane particles (B) contained in the photocurable resin composition disclosed herein will function as a solid lubricant in the cured product and roll at the sliding surface without being broken after curing the photocurable resin composition. Consequently, the cured product exhibits a low friction coefficient. Thus, the resulting cured product has high wear resistance and a low friction coefficient.

Polysilsesquioxane particles (B) used herein have polysilsesquioxane at the surfaces and, desirably, do not substantially dissolve or swell in radically polymerizable compound (A) from the viewpoint of maintaining the shape of the particles. The expression “not substantially dissolve or swell” means that when polysilsesquioxane particles (B) are mixed with radically polymerizable compound (A), the average particle size of polysilsesquioxane particles (B) does not vary.

Although silsesquioxane includes various types differing in molecular structure, such as cage-like, ladder-like, and random-branched structures, and in the number of repeating units, such as low molecular weight, oligomer, and polymer types, at least some embodiments use polysilsesquioxane that is a polymer type and mainly has random-branched structures, which do not dissolve in radically polymerizable compound (A). Also, polysilsesquioxane, in a polymer type, that does not decrease in weight or melt at 400° C. in thermogravimetric analysis may be selected. From the viewpoint of availability, polysilsesquioxane may contain molecular structures having siloxane bonds with one, two, or four oxygens for one silicon, provided that the structure having siloxane bonds with three oxygen for one silicon is the major.

Polysilsesquioxane particles (B) may be made of polysilsesquioxane throughout all the particles or may have a core-shell structure defined by a core made of, for example, silicone rubber and a shell of polysilsesquioxane. It should be noted that polysilsesquioxane particles made of polysilsesquioxane throughout all the particles or having a core-shell structure whose shell is made of polysilsesquioxane contain a trace amount of dimethylsiloxane in the production process, but it does not affect the implementation of the present disclosure.

Polysilsesquioxane particles (B) used herein may have an average particle size of 50 μm or less. In many cases of stereolithography, layers of 200 μm or less in thickness are stacked. Polysilsesquioxane particles with an average particle size of 50 μm or less are less likely to be distributed unevenly within the layers. Also, polysilsesquioxane particles (B) with an average particle size of 0.5 μm or more are less likely to involve significantly increasing the viscosity of the photocurable resin composition. Hence, in some embodiments, the average particle size of polysilsesquioxane particles (B) is from 0.5 μm to 50 μm and may be from 0.7 μm to 5 μm because of availability. Also, from the viewpoint of easily dispersing the photocurable resin composition, polysilsesquioxane particles (B) may be spherical.

The average particle size of polysilsesquioxane particles (B) is the arithmetic mean of the sphere volume equivalent diameters measured by a Coulter Counter method. The Coulter Counter method is based on the following measurement principle.

An electrolyte, in a vessel in which particles are dispersed, is divided into two by a wall with a small through hole. Electrodes are disposed with the wall in between, and a constant current is applied between the electrodes. When the electrolyte on one side of the two, separated by the wall, is drawn by a constant suction force, the particles pass through the small hole with the electrolyte. At this time, the volume of the electrolyte in the small hole decreases by the amount equivalent to the volume of the particles, and the electric resistance of the hole increases in proportion to the decreased volume of the electrolyte. Since a constant current flows through the small hole, the voltage between the electrodes changes in proportion to the change in the electric resistance of the hole. The volume of the particles is measured from the change in voltage, and the sphere volume equivalent diameter is determined from the volume of the particles, thus obtaining the particle size distribution.

More specifically, the measurement is performed, for example, as described below. First, polysilsesquioxane particles are mixed with sodium alkylbenzenesulfonate, and an electrolyte, such as ISOTON-II produced by Beckman Coulter is added to the mixture. Then, the mixture is subjected to dispersion with an ultrasonic dispersion device to prepare a sample. For the measurement by the Coulter Counter method, for example, Multisizer 3 manufactured by Beckman Coulter is used with a 200 μm or 400 μm aperture tube. The sphere volume equivalent diameters and the number of polysilsesquioxane particles are measured with the measurement apparatus for the Coulter Counter method, and the arithmetic mean of the sphere volume equivalent diameters is calculated from the measurement results.

When polysilsesquioxane particles (B) do not have radically polymerizable functional groups in the molecule, the affinity of the particles is not so high for radically polymerizable compound (A), and accordingly, polysilsesquioxane particles (B) are more easily released onto the sliding surface of the cured product when it is slid. Therefore, in some embodiments, polysilsesquioxane particles (B) do not have radically polymerizable functional groups in the molecule. In contrast, when polysilsesquioxane particles (B) have radically polymerizable functional groups in the molecule, the affinity of the particles increases for the radically polymerizable compound (A), and accordingly, the polysilsesquioxane particles are less likely to settle in the photocurable resin composition. Additionally, the adhesion of radically polymerizable compound (A) to the cured product increases to reduce the likelihood that the cured product cracks advantageously. From this viewpoint, polysilsesquioxane particles (B) whose molecule contains a radically polymerizable functional group may be favorable.

Polysilsesquioxane particles (B) used herein may be subjected to chemical surface treatment to increase the dispersibility in the photocurable resin composition and dispersion stability and to prevent aggregation. For example, the chemical surface treatment may be performed with a silane coupling agent. The treated surfaces may be grafted with a low-molecular-weight or high-molecular-weight material. Alternatively, the surfaces of the polysilsesquioxane particles may be coated with a low-molecular-weight or high-molecular weight material.

Polysilsesquioxane particles (B) used herein may be particles of an individual material or a mixture of particles of two or more materials.

The amount of polysilsesquioxane particles (B) in the photocurable resin composition is 5 to 30 parts by mass relative to 100 parts by mass of radically polymerizable compound (A) and may be 10 to 20 parts by mass. When the amount of polysilsesquioxane particles (B) is in such a range, the photocurable resin composition has a viscosity suitable for three-dimensional fabrication, and the product obtained by curing the photocurable resin composition exhibits high sliding properties.

### Curing Agent (C)

Curing agent (C) may be a photo-radical polymerization initiator. Also, the photocurable resin composition disclosed herein may contain a thermal radical polymerization initiator in addition to the photo-radical polymerization initiator. The thermal radical polymerization initiator in the photocurable resin composition can promote polymerization reaction when heat treatment is performed after fabrication by light irradiation and enhances the mechanical strength of the shaped object.

### Photo-Radical Polymerization Initiator

Photo-radical polymerization initiators are mainly classified into intramolecular cleavage type and hydrogen-drawing type. Intramolecular cleavage type initiators absorb light with specific wavelengths to be cleaved at a bond of a specific position, and radicals are generated at the cleaved position and act as a polymerization initiator to induce the polymerization of radically polymerizable compound (A). Hydrogen-drawing type initiators absorb light with specific wavelengths to be excited, and the excited species causes a reaction to draw hydrogen from the surrounding hydrogen donor to generate radicals. Thus generated radicals act as a polymerization initiator to induce the polymerization of radically polymerizable compound (A). In the embodiments, two or more photo-radical polymerization initiators may be used, but an individual one may be used.

Examples of known intramolecular cleavage type photo-radical polymerization initiators include alkylphenone-based photo-radical polymerization initiators, acylphosphine oxide-based photo-radical polymerization initiators, and oxime ester-based photo-radical polymerization initiators. These initiators generate radicals by a cleavage of a bond adjacent to the carbonyl group.

Alkylphenone-based photo-radical polymerization initiators include benzyl methyl ketal-based photo-radical polymerization initiators, α-hydroxyalkylphenone-based photo-radical polymerization initiators, and aminoalkylphenon-based photo-radical polymerization initiators. More specifically, an example of benzyl methyl ketal-based photo-radical polymerization initiators is, but not limited to, 2,2′-dimethoxy-1,2-diphenylethan-1-one (Irgacure® 651, produced by BASF). Examples of α-hydroxyalkylphenone-based photo-radical polymerization initiators include, but are not limited to, 2-hydroxy-2-methyl-1-phenylpropan-1-one (Darocur® 1173, produced by BASF), 1-hydroxycyclohexyl phenyl ketone (Irgacure® 184, produced by BASF), 1-[4-(2-hydroxyethoxy)phenyl]-2-hydroxy-2-methyl-1-propan-1-one (Irgacure® 2959, produced by BASF), and 2-hydroxy-1-{4-[4-(2-hydroxy-2-methylpropionyl)benzyl]phenyl}-2-methylpropan-1-one (Irgacure® 127, produced by BASF). Examples of aminoalkylphenone-based photo-radical polymerization initiators include, but are not limited to, 2-methyl-1-(4-methylthiophenyl)-2-morpholinopropan-1-one (Irgacure® 907, produced by BASF) and 2-benzylmethyl-2-dimethylamino-1-(4-morpholinophenyl)-1-butanone (Irgacure® 369, produced by BASF).

Examples of acylphosphine oxide-based photo-radical polymerization initiators include, but are not limited to, (2,4,6-trimethylbenzoyl)diphenylphosphine oxide (Lucirin® TPO, produced by BASF) and bis(2,4,6-trimethylbenzoyl)phenylphosphine oxide (Omnirad® 819, produced by IGM Resins).

An example of oxime ester-based photo-radical polymerization initiators is, but not limited to, (2E)-2-(benzoyloxyimino)-1-[4-(phenylthio)phenyl]octan-1-one (Irgacure® OXE-01, produced by BASF).

Hydrogen-drawing type photo-radical polymerization initiators include, but are not limited to, anthraquinone derivatives, such as 2-ethyl-9,10-anthraquinone and 2-t-butyl-9,10-anthraquinone; and thioxanthone derivatives, such as isopropylthioxanthone and 2,4-diethylthioxanthone.

The amount of the photo-radical polymerization initiator in the photocurable resin composition may be 0.1 to 15 parts by mass relative to 100 parts by mass in total of the radically polymerizable compounds, and is, in some embodiment, 0.1 to 10 parts by mass. When the amount of the photo-radical polymerization initiator is in such a range, polymerization proceeds sufficiently, and the photocurable resin composition has sufficient transparency and ensures uniform polymerization.

### Thermal Radical Polymerization Initiator

Any thermal radical polymerization initiator can be used without limitation as long as it generates radicals when heated, and exemplary known compounds include azo compounds, peroxides, and persulfates.

Examples of azo-based initiators include 2,2′-azobisisobutyronitrile, 2,2′-azobis(methyl isobutyrate), 2,2′-azobis(2,4-dimethylvaleronitrile), and 1,1′-azobis(1-acetoxy-1-phenylethane).

Examples of peroxide initiators include benzoyl peroxide, di-t-butylbenzoyl peroxide, t-butyl peroxypivalate, and di(4-t-butylcyclohexyl) peroxydicarbonate.

Examples of persulfate initiators include ammonium persulfate, sodium persulfate, and potassium persulfate.

The amount of the thermal radical polymerization initiator, if added, may be 0.1 to 15 parts by mass, for example, 0.1 to 10 parts by mass, relative to 100 parts by mass of radically polymerizable compound (A). The thermal radical polymerization initiator in such an amount leads to an appropriate molecular weight and favorable physical properties.

### Other Constituents

The photocurable resin composition disclosed herein may contain various additives as optional constituents to the extent that they do not impair the object and effect of the disclosure. Such additives include resins such as epoxy resin, polyurethane, polybutadiene, polychloroprene, polyester, styrene-butadiene block copolymers, polysiloxane, petroleum resin, xylene resin, ketone resin, and cellulose resin; engineering plastics, such as polycarbonate, modified polyphenylene ether, polyamide, polyacetal, polyethylene terephthalate, polybutylene terephthalate, polyphenylsulfone, polysulfone, polyarylate, polyetherimide, polyether ether ketone, polyphenylene sulfide, polyethersulfone, polyamide-imide, liquid crystal polymer, polytetrafluoroethylene, polychlorotrifluoroethylene, and polyvinylidene fluoride; reactive monomers and oligomers, such as fluorinated oligomers, silicone oligomers, polysulfide oligomers, fluorine-containing monomers, and siloxane structure-containing monomers; soft metals, such as gold, silver, and lead; substances with layered crystal structures, such as graphite, molybdenum disulfide, tungsten disulfide, boron nitride, graphite fluoride, calcium fluoride, barium fluoride, lithium fluoride, silicon nitride, and molybdenum selenide; polymerization inhibitors, such as phenothiazine, p-methoxyphenol, 2,6-di-t-butyl-4-methylphenol, 2,2,6,6-tetramethylpiperidin-1-oxyl, 4-hydroxy-2,2,6,6-tetramethylpiperidin-1-oxyl, 2-methyl-1,4-naphthoquinone, and benzoquinone; and photo-sensitizers, polymerization initiation aids, leveling agents, wetting improvers, surfactants, plasticizers, UV absorbents, silane coupling agents, inorganic fillers, pigments, dyes, antioxidants, flame retardants, thickeners, rheology controlling agents, antifoaming agents, organic solvents, and fluorescent brightening agents, more specifically, benzoin compounds, acetophenone compounds, anthraquinone compounds, thioxanthone compounds, ketal compounds, benzophenone compounds, tertiary amines, and xanthone compounds.

### Photocurable Resin Composition

The photocurable resin composition disclosed herein is prepared by adding essential constituents: radically polymerizable compound (A), polysilsesquioxane particles (B), and curing agent (C), and, if necessary, appropriate amounts of other optional constituents. More specifically, the photocurable resin composition is prepared by placing these constituents in a stirring vessel and stirring the constituents typically at 30° C. to 120° C., in some embodiments, 50° C. to 100° C. The stirring time is typically 1 minute to 6 hours, in some embodiments, 10 minutes to 2 hours. The total amount of radically polymerizable compound (A) and polysilsesquioxane particles (B) is 75 to 100 parts by mass, for example, 90 to 100 parts by mass, in 100 parts by mass of the photocurable resin composition excluding curing agent (C). The rest of the photocurable resin composition in 100 parts by mass, excluding radical polymerizable compound (A) and polysilsesquioxane particles (B), consists of curing agent (C) and other constituents described above.

The viscosity of the photocurable resin composition at 25° C. may be 50 mPa·s to 30,000 mPa·s or 50 mPa·s to 10,000 mPa·s.

The thus prepared photocurable resin composition is suitable as a material for stereolithography. In other words, a desired shaped object can be produced by irradiating the photocurable resin composition disclosed herein with a light energy beam according to the slice data generated from the three-dimensional shape data of an article to be fabricated (fabrication model) to supply the energy required for curing.

### Cured Product

The cured product mentioned herein is obtained by irradiating the photocurable resin composition with a light energy beam to cure the resin composition. The cured product of the photocurable resin composition disclosed herein contains polysilsesquioxane particles (B) and therefore has a low friction coefficient and high wear resistance. More specifically, the specific amount of wear of the cured product may be less than 0.5 mm³·N⁻¹·km⁻¹ and is, in some embodiments, less than 0.3 mm³·N⁻¹·km⁻¹. Also, the friction coefficient of the cured product may be less than 1.0 and is, in some embodiments, less than 0.5.

Since, in the photocurable resin composition disclosed herein, multifunctional radically polymerizable compound (A-1) has an ethylenically unsaturated group equivalent of 250 g/eq to less than 700 g/eq, the cured product of the photocurable resin composition can exhibit good heat resistance.

### Method for Producing Three-Dimensional Objects

The photocurable resin composition disclosed herein, which contains a photopolymerization initiator, such as a photo-radical polymerization initiator, as curing agent (C), can be suitably used for producing (fabricating) three-dimensional objects by stereolithography. The three-dimensional objects formed of the photocurable resin composition disclosed herein can be produced in a known stereolithography process.

More specifically, the method for producing three-dimensional objects include forming a layer of the photocurable resin composition, and irradiating the layer of the photocurable resin composition with light energy to cure the layer according to slice data of a fabrication model. For manufacturing an article by stereolithography, the shaped object obtained by light irradiation may be subjected to heat treatment. The light energy may be light emitted from a laser light source or projector. An exemplary stereolithography process includes curing the photocurable resin composition layer by layer according to the slice data generated from the three-dimensional shape data of an article to be fabricated. Such processes are classified mainly into two ways: free surface approach and constrained surface approach.

The Figure depicts a configuration of a stereolithography apparatus 100 using a free surface approach. The stereolithography apparatus 100 includes a vat 11 filled with a liquid photocurable resin composition 10. Inside the vat 11, a fabrication stage 12 is disposed so as to be driven in a vertical direction by a drive shaft 13. A light energy beam 15 for curing the photocurable resin composition 10 emitted from a light source 14 is turned to change the irradiation position by a galvanometer mirror 16 controlled according to the slice data by a controller 18 and scan the surface of the photocurable resin composition 10 in the vat 11. In the Figure, the scanning area is indicated by thick dashed lines.

The thickness d of the photocurable resin composition 10 to be cured by the light energy beam 15 is determined based on the settings made when the slice data is generated and affects the precision of the resulting shaped object 17 (reproductivity of the three-dimensional shape date of the article to be fabricated). The thickness d is reached by the controller 18 controlling the driving amount of the drive shaft 13.

First, the controller 18 controls the drive shaft 13 according to the settings, and the photocurable resin composition is supplied onto the fabrication stage 12 to the thickness d. The photocurable resin composition, which is liquid, on the fabrication stage 12 is selectively irradiated with the light energy beam 15 based on the slice data to form a cured layer with a desired pattern. Subsequently, the fabrication stage 12 is moved in the direction of the open arrow, and the uncured photocurable resin composition is supplied onto the cured layer to the thickness d. Then, the photocurable resin composition is irradiated with the light energy beam 15 based on the slice data to form a cured layer integrated with the previously formed cured layer. By repeating this operation for curing a layer of the resin composition, a targeted three-dimensional shaped object 17 is obtained.

The resulting three-dimensional shaped object 17 is removed from the vat 11, and the unreacted photocurable resin composition remaining on the surface of the shaped object is removed, followed by cleaning if necessary. For cleaning, an alcoholic organic solvent, such as isopropyl alcohol or ethyl alcohol, may be used as the cleaning agent. Other organic solvents such as ketones, for example, acetone and methyl ethyl ketone, and ethyl acetate, and aliphatic organic solvents, for example, terpenes, may also be used.

After cleaning with such a cleaning agent, post-curing may be performed by irradiation with light or heat, if necessary. Post-curing can cure the unreacted photocurable resin composition remaining on the surface of and inside the three-dimensional shaped object 17, reduce stickiness at the surface of the shaped object 17, and enhance the initial strength of the shaped object 17.

The light energy beam used in the production process may be UV radiation, electron beams, X-rays, or other radiation. In particular, UV radiation with wavelengths of 300 nm to 450 nm may be used from an economic standpoint. Examples of the light source of UV radiation include UV lasers (e.g., an Ar laser, a He—Cd laser), mercury-vapor lamps, xenon lamps, halogen lamps, and fluorescent lamps. In some embodiments, lasers may be used because lasers can shorten the fabrication time when the energy level is increased and are so excellent in light correction that they provide high fabrication precision with a small irradiation diameter. The light energy beam may be selected according to the radical polymerization initiator contained in the photocurable resin composition and may be a combination of a plurality of types.

When the surface of the photocurable resin composition is irradiated with an optical energy beam to form a cured layer with a predetermined shape pattern, the optical energy beam may be narrowed into dots or a line to cure the resin in a doted or linear manner. Alternatively, the light energy beam may be emitted through a planer drawing mask in which a plurality of tiny shatters are arranged, such as a liquid crystal shutter or a digital micromirror shutter, to cure the resin in a planer manner.

Also, a constrained surface approach may be taken for the fabrication. In a stereolithography apparatus using a constrained surface approach, the fabrication stage 12 of the stereolithography apparatus 100 depicted in the Figure is disposed so that the shaped object can be lifted above the liquid surface, and a light irradiation device is disposed below the vat 11. An exemplary constrained surface approach is performed as follows. First, a liftable support stage and a vat containing a photocurable resin composition are disposed so that the support face of the support stage and the bottom of the vat have a predetermined distance, and the photocurable resin composition is supplied between the support face of the support stage and the bottom of the vat. Subsequently, the photocurable resin composition between the support face and the bottom of the vat is selectively irradiated with light according to the slice data from a laser light source or projector located on the bottom side of the vat containing the photocurable resin composition. Light irradiation cures the photocurable resin composition between the support face of the stage and the bottom of the vat to form a solid cured resin layer. Then, the stage is lifted to separate the cured resin layer from the bottom of the vat.

The support stage is then adjusted to a height to have a predetermined distance between the cured layer on the support stage and the bottom of the vat. The light is emitted selectively in the same manner as above to form another cured resin layer between the previously cured resin layer and the bottom of the vat, thus integrated with the previously cured layer. Such a process is repeated a predetermined number of times with or without changing the pattern to be irradiated, thus forming a three-dimensional shaped object defined by integrated cured resin layers.

### Applications

The photocurable resin composition disclosed herein and articles that are cured products of the photocurable resin composition can be used in any application without limitation. For example, they can be used as stereolithography 3D printer resin, sporting goods, nursing medical care supplies, custom-made products such as prosthetic limbs, dentures, and artificial bones, industrial machinery and apparatuses, precision instruments, electrical and electronic apparatuses, electrical and electronic components, and building materials.

### EXAMPLES

The present disclosure will be further described with reference to Examples, but it is not limited to the following Examples.

### Constituents

Materials used as constituents in Examples and Comparative Examples are as follows:

### Multifunctional Radically Polymerizable Compound (A-1)

Compounds used as multifunctional radically polymerizable compound (A-1) in Examples and Comparative Examples are presented in Table 1.

TABLE 1

| | | | Average | Weight | | | |
|---|---|---|---|---|---|---|---|
| | | | number of | average | Ethylenically | | |
| | | Functional | functional | molecular | unsaturated group | | |
| | Compound | group | groups | weight | equivalent [g/eq] | Supplier | Trade name |
| A-1-1 | Urethane | Acryloyl | 6.5 | 1500 | 231 | Mitsubishi | SHIKOH ™ |
| | acrylate | | | | | Chemical | UV-7640B |
| A-1-2 | Urethane | Acryloyl | 2.5 | 2000 | 800 | Mitsubishi | SHIKOH ™ |
| | acrylate | | | | | Chemical | UV-7550B |
| A-1-3 | Urethane | Acryloyl | 2.0 | 3000 | 1500 | Mitsubishi | SHIKOH ™ |
| | acrylate | | | | | Chemical | UV-6630B |
| A-1-4 | Ethoxylated | Acryloyl | 3.0 | 423 | 141 | Shin- | NK ESTETR |
| | isocyanuric | | | | | Nakamura | A9300 |
| | acid | | | | | Chemical | |
| | triacrylate | | | | | | |
| A-1-5 | Diacrylate | Acryloyl | 2.0 | 304 | 152 | Shin- | NK ESTETR |
| | with alicyclic | | | | | Nakamura | A-DCP |
| | structure | | | | | Chemical | |
| A-1-6 | Ethoxylated | Acryloyl | 2.0 | 466 | 233 | Shin- | NK ESTETR |
| | bisphenol A | | | | | Nakamura | ABE-300 |
| | diacrylate | | | | | Chemical | |
| A-1-7 | Ethoxylated | Acryloyl | 2.0 | 512 | 256 | Shin- | NK ESTETR |
| | bisphenol A | | | | | Nakamura | BPE-4 |
| | diacrylate | | | | | Chemical | |
| A-1-8 | Urethane | Acryloyl | 2.5 | 3000 | 1200 | Mitsubishi | SHIKOH ™ |
| | acrylate | | | | | Chemical | UV-2750B |
| A-1-9 | Urethane | Acryloyl | 2.0 | 2800 | 1400 | Mitsubishi | SHIKOH ™ |
| | acrylate | | | | | Chemical | UV-7000B |

### Polysilsesquioxane Particles (B)

### B-1: Hybrid Silicone Powder KMP-600, Produced by Shin-Etsu Chemical

This powder is hybrid particles having a core-shell structure. The core is mainly made of cross-linked polydimethylsiloxane (silicone rubber), and the shell is made of random-branched polysilsesquioxane with methyl groups as organic substituents and contains a trace amount of dimethylsiloxane. The powder does not substantially dissolve or swell in either multifunctional radically polymerizable compound (A-1) or mixtures of multifunctional radically polymerizable compound (A-1) and monofunctional radically polymerizable compound (A-2). The particles are spherical and have an average particle size of 5.0 μm and a shell thickness of 70 nm.

### B-2: Hybrid Silicone Powder X-52-7030, Produced by Shin-Etsu Chemical.

This powder is hybrid particles having a core-shell structure. The core is mainly made of cross-linked polydimethylsiloxane (silicone rubber), and the shell is made of random-branched polysilsesquioxane with methyl groups as organic substituents and contains a trace amount of dimethylsiloxane. The powder does not substantially dissolve or swell in either multifunctional radically polymerizable compound (A-1) or mixtures of multifunctional radically polymerizable compound (A-1) and monofunctional radically polymerizable compound (A-2). The particles are spherical and have an average particle size of 0.8 μm and a shell thickness of 25 nm.

### B-3: Silicone Resin Powder X-52-1621, Produced by Shin-Etsu Silicone.

This powder is entirely made of random-branched polysilsesquioxane with methyl groups as organic substituents and contains a trace amount of dimethylsiloxane. The powder does not substantially dissolve or swell in either multifunctional radically polymerizable compound (A-1) or mixtures of multifunctional radically polymerizable compound (A-1) and monofunctional radically polymerizable compound (A-2). The particles do not exhibit thermal weight loss or melt at 400° C. and have an average particle size of 5.0 μm.

### B-4: Silicone Resin Powder X-52-854, Produced by Shin-Etsu Silicone

This powder is entirely made of random-branched polysilsesquioxane with methyl groups as organic substituents and contains a trace amount of dimethylsiloxane. The powder does not substantially dissolve in either multifunctional radically polymerizable compound (A-1) or mixtures of multifunctional radically polymerizable compound (A-1) and monofunctional radically polymerizable compound (A-2). The particles do not exhibit thermal weight loss or melt at 400° C. and have an average particle size of 0.7 μm.

### Measurement of Average Particle Size

First, 5 mg of polysilsesquioxane particles were mixed with 2 mL of sodium alkylbenzenesulfonate, and the mixture was added to 100 mL of an electrolyte, ISOTON-II, produced by Beckman Coulter. Then, the resulting mixture was subjected to dispersion for 5 minutes with an ultrasonic dispersion device to prepare a sample. Multisizer 3, manufactured by Beckman Coulter, was used as a measurement apparatus for the Coulter Counter method with a 200 μm or 400 μm aperture tube. The sphere volume equivalent diameters and the number of polysilsesquioxane particles were measured with the above measurement apparatus, and the average particle size (arithmetic mean of the sphere volume equivalent diameters) was determined from the measurement results.

### Curing Agent (C)

C-1: Omnirad 819 (photo-radical polymerization initiator, bis(2,4,6-trimethylbenzoyl)phenylphosphine oxide, produced by IGM Resins) Monofunctional Radically Polymerizable Compound (A-2)

Compounds used as monofunctional radically polymerizable compound (A-2) in Examples and Comparative Examples are presented in Table 2.

TABLE 2

| | Compound | Compound | | Trade |
|---|---|---|---|---|
| | type | name | Supplier | name |
| A-2-1 | Acrylamide- | 4- | KJ Chemicals | ACMO |
| | based | Acryloyl- | | |
| | compound | morpholine | | |
| A-2-2 | Maleimide- | N- | Nippon | IMILEX ™-P |
| | based | Phenyl- | Shokubai | |
| | compound | maleimide | | |
| A-2-3 | Acrylate | Isobornyl | Tokyo Chemical | Same as the |
| | | acrylate | Industry | compound name |
| A-2-4 | N-Vinyl | N-Vinyl-ε- | Tokyo Chemical | Same as the |
| | compound | caprolactam | Industry | compound name |

### Other Constituents (D)

D-1:4-Hydroxy-2,2,6,6-tetramethylpiperidin-1-oxyl, produced by Merck
D-2:4-Methoxyphenol, produced by Tokyo Chemical Industry
D-3: Silicone Rubber Powder KMP-597, produced by Shin-Etsu Silicone

This is spherical particles with a cross-linked dimethylsiloxane structure and an average particle size of 5.0 μm. The particles absorb multifunctional radically polymerizable compound (A-1) and mixtures of multifunctional radically polymerizable compound (A-1) and monofunctional radically polymerizable compound (A-2) and thus swell. The average particle size was measured by the same method as polysilsesquioxane particles (B).
D-4: PSS-Octamethyl substituted, produced by Sigma-Aldrich

This compound mainly contains cage-like silsesquioxane with methyl groups as organic substituents and dissolves in multifunctional radically polymerizable compound (A-1) and mixtures of multifunctional radically polymerizable compound (A-1) and monofunctional radically polymerizable compound (A-2).

### Example 1

### Preparation of Photocurable Resin Composition

The constituents presented in Tables 3 to 5 were mixed, heated to 75° C., and stirred with a stirrer for 2 hours to prepare a photocurable resin composition. The values of constituents in the Tables are each expressed in parts by mass.

Each amount of multifunctional radically polymerizable compound (A-1) and monofunctional radically polymerizable compound (A-2) presented in Tables 3 and 4 is the proportion in parts by mass of the corresponding compound relative to 100 parts by mass in total of multifunctional radically polymerizable compound (A-1) and monofunctional radically polymerizable compound (A-2). The amount of polysilsesquioxane particles (B) is represented by the proportion of polysilsesquioxane particles (B) relative to 100 parts by mass in total of multifunctional radically polymerizable compound (A-1) and monofunctional polymerizable compound (A-2).

The resin composition of Example 1 contains a plurality of multifunctional polymerizable compounds as multifunctional radically polymerizable compound (A-1), which are in a mixture of a multifunctional radically polymerizable compound with an ethylenically unsaturated group equivalent of 250 g/to less than 700 g/eq and multifunctional radically polymerizable compounds with an ethylenically unsaturated group equivalent of less than 250 g/eq.

### Production of Specimen X

The following specimen was produced using the prepared photocurable resin composition. First, the photocurable resin composition was poured into a mold of 80 mm in length, 10 mm in width, and 4 mm in thickness sandwiched between two quartz glass plates. The photocurable resin composition poured was irradiated on both sides with UV light, each at 5 mW/cm² for 360 s using a UV irradiation device, “LIGHT SOURCE EXECURE 3000” (trade name), manufactured by HOYA CANDEO OPTRONICS. The total energy emitted to cure the photocurable resin composition was 3600 mJ/cm². The resulting cured product was heat-treated in a heating oven of 50° C. for 1 hour and in a heating oven of 100° C. for 2 hours to obtain specimen X of 80 mm in length, 10 mm in width, and 4 mm in thickness. Specimen X was used to measure deflection temperature under load, which will be described later.

### Production of Specimen Y

A shaped object was formed with the prepared photocurable resin composition according to slice data based on a 30 mm×30 mm×4 mm three-dimensional rectangular solid, using a 3D printer (constrained surface stereolithography apparatus DWS-020X manufactured by DWS). The shaped object was formed by stacking 50 μm-thick 30 mm×4 mm cured layers up to a height of 30 mm. The resulting shaped object was rinsed with isopropanol, and the support member was removed. Then, the object was irradiated with UV light for 30 minutes with UV Curing Unit M manufactured by DWS and heat-treated in a heating oven of 50° C. for 1 hour and in a heating oven of 100° C. for 2 hours to obtain specimen Y. Specimen Y was used to evaluate the formability and sliding properties.

### Evaluation

### Formability

The formability was evaluated in terms of the dimensional errors of specimen Y from the 30 mm×30 mm×4 mm shape. The results were rated according to the following criteria. Specimens satisfying the criterion of rating B are good in formability, and specimens satisfying the criterion of rating A are excellent in formability. The dimensional measurements along each edge were performed before the above-described heat treatment in the heating ovens. The results are presented in Tables 3 to 5.
A: Dimensional errors were within |±3|%.
B: Dimensional errors were larger than |±3|%.
C: The composition was not shaped, or the shaped object was damaged when removed from the support.

### Deflection Temperature Under Load

The deflection temperature under load was measured according to JIS K 7191 under the following conditions:
Measurement apparatus: 3M-2, manufactured by Tokyo Chemical Industry
Test environment: 23° C.±2° C., 50% RH±5% RH
Specimen: Specimen X, with a face of 80 mm long x 10 mm wide as the bottom
Flexural stress: 1.8 MPa
Initial temperature: 30° C., kept for 5 minutes
Heating rate: 120° C./h

The strain of specimen X was measured while the temperature was increased at a heating rate of 120° C./h. The temperature at which the strain increased by 0.34 mm from the initial value was defined as the deflection temperature under load, which was used as the index of heat resistance. The evaluation criteria for heat resistance are as follows. Specimens satisfying the criterion of rating B are good in heat resistance, and specimens satisfying the criterion for rating A are excellent in heat resistance. The results are presented in Tables 3 to 5.
A: 95° C. or more
B: 85° C. to less than 95° C.
C: Less than 85° C.

### Sliding Properties

The friction coefficient and the specific amount of wear were measured as sliding properties. Measuring conditions were in accordance with Method A specified in JIS K 7218. Details are as follows:
Measuring apparatus: Friction and Wear Tester MODEL EMF-III-F, manufactured by A&D Company
Test environment: 23° C.±2° C., 50% RH±5% RH
Specimen: Specimen Y (30 mm×30 mm in area, 4 mm in thickness)
Counter member: made of S45C steel, ring shape, about 0.8 μmRa in surface roughness, 2 cm² in contact area, 50 N in load
Sliding speed: 50 cm/s
Testing time: 100 minutes
Sliding distance: 3 km

### (1) Specific Amount of Wear

A counter member was pressed against a 30 mm×30 mm face of specimen Y at the above load and slid at the above speed. After 100 minutes, the sliding was stopped, and the weight of wear was determined from the weights of specimen Y before and after the sliding. The volume of wear was calculated from the measured weight of wear and the specific gravity of specimen Y. The calculated volume of wear was divided by the sliding distance and the load, and the quotient was defined as the specific amount of wear (unit: mm³·N⁻¹·km⁻¹), which was used as an index of wear resistance. The evaluation criteria for wear resistance are as follows. When the depth of wear exceeded 1.5 mm within 100 minutes after the start of sliding, the result was rated C as the limit of measurement. Specimens satisfying the criterion of rating B are good in wear resistance, and specimens satisfying the criterion for rating A are excellent in wear resistance. The results are presented in Tables 3 to 5.
A: Less than 0.3 mm³·N⁻¹·km⁻¹
B: 0.3 mm³·N⁻¹·km⁻¹ to less than 0.5 mm³·N⁻¹·km⁻¹
c: 0.5 mm³·N⁻¹·km⁻¹ or more

### (2) Friction Coefficient

The friction coefficient was calculated by dividing the average frictional force for 10 seconds before and after the time of 60 minutes after the start of sliding by the load. The evaluation criteria for friction coefficient are as follows. Specimens satisfying the criterion of rating B are good in friction coefficient, and specimens satisfying the criterion for rating A are excellent in friction coefficient. The results are presented in Tables 3 to 5.
A: Less than 0.5
B: 0.5 to less than 1.0
C: 1.0 or more

### Examples 2 to 17, Comparative Examples 1 to 7

Curable resin compositions were prepared in the same manner as in Example 1, except that the constituents and their amounts were changed as presented in Table 3 or 4, and evaluated as in Example 1. The results are presented in Tables 3 to 5.

The resin composition of Comparative Example 1 contains a plurality of multifunctional radically polymerizable compounds as multifunctional radically polymerizable compound (A-1), as in Example 1, and these compounds are in a mixture of multifunctional radically polymerizable compounds with an ethylenically unsaturated group equivalent of less than 250 g/eq.

In Examples 2 to 17 and Comparative Examples 2 to 7, multifunctional radically polymerizable compound (A-1) is a mixture containing a multifunctional radically polymerizable compound with an ethylenically unsaturated group equivalent of more than 700 g/eq, and the mixing ratio is adjusted so that the ethylenically unsaturated group equivalent is from 250 g/eq to less than 700 g/eq.

TABLE 3

| | | | Example | Example | Example | Example | Example |
|---|---|---|---|---|---|---|---|
| | | | 1 | 2 | 3 | 4 | 5 |
| Resin | Multifunctional | A-1-1 | 40 | — | — | — | — |
| composition | radically | A-1-2 | — | 40 | 40 | 40 | 40 |
| | polymerizable | A-1-3 | — | — | — | — | — |
| | compound (A-1) | A-1-4 | — | — | — | — | — |
| | | A-1-5 | 10 | 15 | 15 | 15 | 15 |
| | | A-1-6 | | 10 | 10 | 10 | 10 |
| | | A-1-7 | 10 | — | — | — | — |
| | Ethylenically unsaturated | | 253 | 563 | 563 | 563 | 563 |
| | group equivalent [g/eq] | | | | | | |
| | Monofunctional | A-2-1 | 40 | 35 | — | — | 35 |
| | radically | A-2-2 | — | — | 35 | — | — |
| | polymerizable | A-2-3 | — | — | — | 35 | — |
| | compound (A-2) | | | | | | |
| | Polysilsesquioxane | B-1 | 10 | 10 | 10 | 10 | — |
| | particles (B) | B-2 | — | — | — | — | 10 |
| | | B-3 | — | — | — | — | — |
| | Curing agent (C) | C-1 | 1 | 1 | 1 | 1 | 1 |
| | Other | D-1 | 0.005 | 0.005 | 0.005 | 0.005 | 0.005 |
| | constituents (D) | D-2 | 0.05 | 0.05 | 0.05 | 0.05 | 0.05 |
| | | D-3 | — | — | — | — | — |
| | | D-4 | — | — | — | — | — |
| Evaluation | Formability | | A | A | A | A | A |
| | Heat resistance | Deflection | 110 | 101 | 104 | 91 | 101 |
| | | temperature | | | | | |
| | | under load [° C.] | | | | | |
| | | Rating | A | A | A | B | A |
| | Specific amount | Measurement | 0.08 | 0.05 | 0.05 | 0.10 | 0.48 |
| | of wear | [mm³ · km⁻¹ · N⁻¹] | | | | | |
| | | Rating | A | A | A | A | B |
| | Friction | Measurement [—] | 0.28 | 0.25 | 0.26 | 0.36 | 0.81 |
| | coefficient | Rating | A | A | A | A | B |

| | | | Example | Example | Comparative | Comparative |
|---|---|---|---|---|---|---|
| | | | 6 | 7 | Example 1 | Example 2 |
| Resin | Multifunctional | A-1-1 | — | — | 40 | — |
| composition | radically | A-1-2 | 40 | — | — | — |
| | polymerizable | A-1-3 | — | 25 | — | 30 |
| | compound (A-1) | A-1-4 | — | 20 | — | — |
| | | A-1-5 | 15 | 15 | 10 | 20 |
| | | A-1-6 | 10 | 10 | 15 | 20 |
| | | A-1-7 | — | — | — | — |

| Ethylenically unsaturated | | 563 | 642 | 219 | 753 |
|---|---|---|---|---|---|
| group equivalent [g/eq] | | | | | |
| Monofunctional | A-2-1 | 35 | 30 | 35 | 30 |
| radically | A-2-2 | — | — | — | — |
| polymerizable | A-2-3 | — | — | — | — |
| compound (A-2) | | | | | |
| Polysilsesquioxane | B-1 | — | 10 | 10 | 10 |
| particles (B) | B-2 | — | — | — | — |
| | B-3 | 10 | — | — | — |
| Curing agent (C) | C-1 | 1 | 1 | 1 | 1 |
| Other | D-1 | 0.005 | 0.005 | 0.005 | 0.005 |
| constituents (D) | D-2 | 0.05 | 0.05 | 0.05 | 0.05 |
| | D-3 | — | — | — | — |
| | D-4 | — | — | — | — |

| | | | | | |
|---|---|---|---|---|---|
| Evaluation | Formability | A | A | C | A |

| | | | | | |
|---|---|---|---|---|---|
| Heat resistance | Deflection | 102 | 100 | 112 | 76 |
| | temperature | | | | |
| | under load [° C.] | | | | |
| | Rating | A | A | A | C |
| Specific amount | Measurement | 0.20 | 0.10 | 0.09 | 0.08 |
| of wear | [mm³ · km⁻¹ · N⁻¹] | | | | |
| | Rating | A | A | A | A |
| Friction | Measurement [—] | 0.35 | 0.26 | 0.25 | 0.25 |
| coefficient | Rating | A | A | A | A |

TABLE 4

| | | | Example | Example | Example | Example | Example | Comparative |
|---|---|---|---|---|---|---|---|---|
| | | | 8 | 9 | 10 | 11 | 12 | Example 3 |
| Resin | Multifunctional | A-1-1 | — | — | — | — | — | — |
| composition | radically | A-1-2 | 62 | 58 | 47 | 40 | 40 | 40 |
| | polymerizable | A-1-3 | — | — | — | — | — | — |
| | compound (A-1) | A-1-4 | — | — | — | — | — | — |
| | | A-1-5 | 23 | 22 | 18 | 15 | 15 | 15 |
| | | A-1-6 | 15 | 15 | 12 | 10 | 10 | 10 |
| | | A-1-7 | — | — | — | — | — | — |
| | Ethylenically unsaturated | | 563 | 563 | 563 | 563 | 563 | 563 |
| | group equivalent [g/eq] | | | | | | | |
| | Monofunctional | A-2-1 | — | 5 | 23 | 35 | 35 | 35 |
| | radically | A-2-2 | — | — | — | — | — | — |
| | polymerizable | A-2-3 | — | — | — | — | — | — |
| | compound (A-2) | | | | | | | |
| | Polysilsesquioxane | B-1 | 10 | 10 | 10 | 5 | 30 | — |
| | particles (B) | B-2 | — | — | — | — | — | — |
| | | B-3 | — | — | — | — | — | — |
| | Curing agent (C) | C-1 | 1 | 1 | 1 | 1 | 1 | 1 |
| | Other | D-1 | 0.005 | 0.005 | 0.005 | 0.005 | 0.005 | 0.005 |
| | constituents (D) | D-2 | 0.05 | 0.05 | 0.05 | 0.05 | 0.05 | 0.05 |
| | | D-3 | — | — | — | — | — | — |
| | | D-4 | — | — | — | — | — | — |
| Evaluation | Formability | | B | A | A | A | B | A |
| | Heat resistance | Deflection | 85 | 87 | 102 | 101 | 91 | 97 |
| | | temperature | | | | | | |
| | | under load [° C.] | | | | | | |
| | | Rating | B | B | A | A | B | A |
| | Specific amount | Measurement | 0.07 | 0.06 | 0.06 | 0.28 | 0.06 | Measurement |
| | of wear | [mm³ · km⁻¹ · N⁻¹] | | | | | | limit |
| | | Rating | A | A | A | A | A | C |
| | Friction | Measurement [—] | 0.25 | 0.26 | 0.26 | 0.48 | 0.17 | 1.05 |
| | coefficient | Rating | A | A | A | A | A | C |

| | | | Comparative | Comparative | Comparative | Comparative |
|---|---|---|---|---|---|---|
| | | | Example 4 | Example 5 | Example 6 | Example 7 |
| Resin | Multifunctional | A-1-1 | — | — | — | — |
| composition | radically | A-1-2 | 40 | 40 | 40 | 34 |
| | polymerizable | A-1-3 | — | — | — | — |
| | compound (A-1) | A-1-4 | — | — | — | — |
| | | A-1-5 | 15 | 15 | 15 | 13 |
| | | A-1-6 | 10 | 10 | 10 | 8 |
| | | A-1-7 | — | — | — | — |
| | Ethylenically unsaturated | | 563 | 563 | 563 | 563 |
| | group equivalent [g/eq] | | | | | |
| | Monofunctional | A-2-1 | 35 | 35 | 35 | 45 |
| | radically | A-2-2 | — | — | — | — |
| | polymerizable | A-2-3 | — | — | — | — |
| | compound (A-2) | | | | | |
| | Polysilsesquioxane | B-1 | 35 | — | — | 10 |
| | particles (B) | B-2 | — | — | — | — |
| | | B-3 | — | — | — | — |
| | Curing agent (C) | C-1 | 1 | 1 | 1 | 1 |
| | Other | D-1 | 0.005 | 0.005 | 0.005 | 0.005 |
| | constituents (D) | D-2 | 0.05 | 0.05 | 0.05 | 0.05 |
| | | D-3 | — | 10 | — | — |
| | | D-4 | — | — | 10 | — |
| Evaluation | Formability | | C | A | A | A |
| | Heat resistance | Deflection | Unformable | 94 | 91 | 83 |
| | | temperature | | | | |
| | | under load [° C.] | | | | |
| | | Rating | — | B | B | C |
| | Specific amount | Measurement | Unformable | Measurement | Measurement | 0.12 |
| | of wear | [mm³ · km⁻¹ · N⁻¹] | | limit | limit | |
| | | Rating | — | C | C | A |
| | Friction | Measurement [—] | Unformable | 0.89 | 0.75 | 0.28 |
| | coefficient | Rating | — | B | B | A |

TABLE 5

| | | | Example | Example | Example | Example | Example |
|---|---|---|---|---|---|---|---|
| | | | 13 | 14 | 15 | 16 | 17 |
| Resin | Multifunctional | A-1-1 | — | — | — | — | — |
| composition | radically | A-1-2 | 40 | 40 | — | — | 40 |
| | polymerizable | A-1-3 | — | — | — | — | — |
| | compound (A-1) | A-1-4 | — | — | 15 | 15 | — |
| | | A-1-5 | 15 | 15 | 15 | 15 | 15 |
| | | A-1-6 | 10 | 10 | 10 | 10 | 10 |
| | | A-1-7 | — | — | — | — | — |
| | | A-1-8 | — | — | 30 | — | — |
| | | A-1-9 | — | — | — | 30 | — |
| | Ethylenically unsaturated | | 563 | 563 | 610 | 696 | 563 |
| | group equivalent [g/eq] | | | | | | |
| | Monofunctional | A-2-1 | — | 35 | 30 | 30 | 35 |
| | radically | A-2-2 | — | — | — | — | — |
| | polymerizable | A-2-3 | — | — | — | — | — |
| | compound (A-2) | A-2-4 | 35 | — | — | — | — |
| | Polysilsesquioxane | B-1 | 10 | — | 10 | 10 | 20 |
| | particles (B) | B-2 | — | — | — | — | — |
| | | B-3 | — | — | — | — | — |
| | | B-4 | — | 10 | — | — | — |
| | Curing agent (C) | C-1 | 1 | 1 | 1 | 1 | 1 |
| | Other | D-1 | 0.005 | 0.005 | 0.005 | 0.005 | 0.005 |
| | constituents (D) | D-2 | 0.05 | 0.05 | 0.05 | 0.05 | 0.05 |
| | | D-3 | — | — | — | — | — |
| | | D-4 | — | — | — | — | — |
| Evaluation | Formability | | A | A | A | A | A |
| | Heat resistance | Deflection | 91 | 100 | 99 | 98 | 97 |
| | | temperature | | | | | |
| | | under load [° C.] | | | | | |
| | | Rating | B | A | A | A | A |
| | Specific amount | Measurement | 0.10 | 0.48 | 0.06 | 0.08 | 0.06 |
| | of wear | [mm³ · km⁻¹ · N⁻¹] | | | | | |
| | | Rating | A | B | A | A | A |
| | Friction | Measurement [—] | 0.36 | 0.79 | 0.27 | 0.27 | 0.19 |
| | coefficient | Rating | A | B | A | A | A |

Tables 3 to 5 show that Examples 1 to 17, which are according to the present disclosure, are good in formability. Specimens X formed by curing the photocurable resin compositions according to the present disclosure exhibited deflection temperatures under load of 85° C. or more, friction coefficients of less than 1.0, and specific amounts of wear of less than 0.5 mm³·N⁻¹·km⁻¹. These results suggest that the photocurable resin composition disclosed herein can provide articles with good heat resistance and high sliding properties.

In Comparative Example 1, in which multifunctional radically polymerizable compound (A-1) had an ethylenically unsaturated group equivalent of less than 250 g/eq, the shaped object chipped partially when removed from the support member and was not able to have an intended three-dimensional shape, as shown in Table 3. In Comparative Example 2, the ethylenically unsaturated group equivalent of multifunctional radically polymerizable compound (A-1) was 700 g/eq or more, and the heat resistance did not exceed the criterion of rating B. These results and the results of Examples 1 to 17 suggest that an appropriate ethylenically unsaturated group of multifunctional radically polymerizable compound (A-1) can be from 250 g/eq to less than 700 g/eq.

As shown in Table 4, the resin composition of Comparative Example 3, which did not contain polysilsesquioxane particles (B), did not satisfy the criterion of rating B for either friction coefficient or wear resistance. In Comparative Example 4, in which the amount of polysilsesquioxane particles (B) was 35 parts by mass, the viscosity of the photocurable resin composition increased so as not to form a three-dimensional shaped object. These results and the results of Examples 1 to 17 suggest that the amount of polysilsesquioxane particles (B) can be 5 to 30 parts by mass relative to 100 parts by mass in total of multifunctional radically polymerizable compound (A-1) and monofunctional polymerizable compound (A-2).

In Comparative Example 5, which used polysiloxane particles D-3 (mainly having siloxane bonds with two oxygen atoms for one silicon atom) instead of polysilsesquioxane particles (B), and Comparative Example 6, which used cage-like silsesquioxane compound D-4 with methyl groups as substituents, the wear resistance did not satisfy the criterion of rating B. These results and the results of Examples 1 to 17 suggest that random-branched polysilsesquioxane insoluble in radically polymerizable compound (A) and mainly containing silsesquioxane having siloxane bonds with three oxygen atoms for one silicon atom is favorable.

In Comparative Example 7, in which the amount of monofunctional radically polymerizable compound (A-2) was 45 parts by mass, the heat resistance did not satisfy the criterion of rating B. The photocurable resin composition of Example 8, which contained only multifunctional radically polymerizable compound (A-1) as radically polymerizable compound (A) without containing monofunctional radically polymerizable compound (A-2), exhibited high viscosity, and the formability was rated B. This result and the results of Examples 1 to 7 and 9 to 17 suggest that an appropriate amount of monofunctional radically polymerizable compound (A-2) can be from 5 to less than 40 parts by mass.

As shown in Table 3, the resin compositions of Examples 2 and 3, which contained an acrylamide-based or a maleimide-based compound as monofunctional radically polymerizable compound (A-2), were rated A for heat resistance. However, the resin composition of Example 4, which contained an acrylate as monofunctional radically polymerizable compound (A-2), was rated B for heat resistance. This suggests that acrylamide-based and acrylamide-based compounds are more favorable as monofunctional radically polymerizable compound (A-2).

Example 2, in which polysilsesquioxane particles (B) had an average particle size of 5.0 μm, was rated A for both wear resistance and friction coefficient, whereas Examples 5 and 14, in which the average particle size was 0.8 μm and 0.7 μm, respectively, was rated B for both wear resistance and friction coefficient. The surface roughness of three-dimensional shaped objects obtained herein is on the order of micrometers. Accordingly, larger polysilsesquioxane particles (B) are more likely to roll on the sliding surface. Therefore, Example 2, which used polysilsesquioxane particles (B) with a larger average particle size, was evaluated better than Examples 5 and 14 in terms of sliding properties.

Polysilsesquioxane particles (B) that are not sufficiently small in average particle size to the thickness of the layers to be stacked are expected to affect the adhesion at the interface between layers in fabrication using 3D printers. In view of the results of Examples 1 to 17, an appropriate average particle size of polysilsesquioxane particles (B) can be 5.0 μm or less, depending on the specifications of the apparatus and conditions for fabrication.

The formability and the heat resistance in Examples 10 and 11, in which 10 parts and 5 parts by mass of polysilsesquioxane particles (B) were added, respectively, were both rated A. In contrast, Example 12, in which 30 parts by mass of polysilsesquioxane particles (B) were added, was rated B for both. When polysilsesquioxane particles having a core-shell structure whose core is made of soft silicone rubber are used as polysilsesquioxane particles (B), as the amount of polysilsesquioxane particles is increased, the viscosity of the photocurable resin composition increases, and the fabrication precision decreases. Also, as the amount of polysilsesquioxane particles is increased, the heat resistance decreases. Thus, the amount of polysilsesquioxane particles (B) can be 30 parts by mass or less.

The photocurable resin composition for three-dimensional fabrication, disclosed herein, can provide shaped objects with excellent heat resistance and sliding properties.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-100876 filed Jun. 20, 2023 and No. 2024-079334 filed May 15, 2024, which are hereby incorporated by reference herein in their entirety.

What is claimed is:

1. A photocurable resin composition comprising:
a radically polymerizable compound (A) including at least multifunctional radically polymerizable compound (A-1) in more than 60% by mass, the multifunctional radically polymerizable compound (A-1) having an ethylenically unsaturated group equivalent of 250 g/eq to less than 700 g/eq;
polysilsesquioxane particles (B) having polysilsesquioxane at least at the surface thereof, the polysilsesquioxane particles being in a proportion of 5 to 30 parts by mass relative to 100 parts by mass of the radical polymerizable compound (A); and
a curing agent (C).

2. The photocurable resin composition according to claim 1, wherein the radically polymerizable compound (A) is a mixture of the multifunctional radically polymerizable compound (A-1) and monofunctional radically polymerizable compound (A-2), and wherein the amount of the monofunctional radically polymerizable compound (A-2) is from 5 to less than 40 parts by mass relative to 100 parts by mass in total of the multifunctional radically polymerizable compound (A-1) and the monofunctional radically polymerizable compound (A-2).

3. The photocurable resin composition according to claim 2, wherein the amount of the monofunctional radically polymerizable compound (A-2) is from 5 to less than 25 parts by mass relative to 100 parts by mass in total of the multifunctional radically polymerizable compound (A-1) and the monofunctional radically polymerizable compound (A-2).

4. The photocurable resin composition according to claim 2, wherein the monofunctional radically polymerizable compound (A-2) is selected from the group consisting of acrylamide-based compounds, N-vinyl compounds, and maleimide-based compounds.

5. The photocurable resin composition according to claim 1, wherein the polysilsesquioxane particles (B) are entirely made of polysilsesquioxane.

6. The photocurable resin composition according to claim 1, wherein the polysilsesquioxane particles (B) have a core-shell structure including a shell made of polysilsesquioxane.

7. The photocurable resin composition according to claim 1, wherein the polysilsesquioxane is predominantly of random type.

8. The photocurable resin composition according to claim 1, wherein the polysilsesquioxane particles (B) have an average particle size of 0.7 μm to 5.0 μm.

9. The photocurable resin composition according to claim 1, wherein the multifunctional radically polymerizable compound (A-1) is an individual multifunctional radically polymerizable compound with an ethylenically unsaturated group equivalent of 250 g/eq to less than 700 g/eq.

10. The photocurable resin composition according to claim 1, wherein the multifunctional radically polymerizable compound (A-1) includes a plurality of multifunctional radically polymerizable compounds, and the mass-weighted average of the ethylenically unsaturated group equivalents of the plurality of multifunctional radically polymerizable compounds is from 250 g/eq to less than 700 g/eq.

11. The photocurable resin composition according to claim 10, wherein the multifunctional radically polymerizable compound (A-1) includes a multifunctional radically polymerizable compound with an ethylenically unsaturated group equivalent of 700 g/eq or more.

12. The photocurable resin composition according to claim 1, wherein the multifunctional radically polymerizable compound (A-1) has an ethylenically unsaturated group equivalent of 400 g/eq to less than 700 g/eq.

13. The photocurable resin composition according to claim 1, wherein the multifunctional radically polymerizable compound (A-1) is at least one (meth)acrylate-based or urethane (meth)acrylate-based compound having a structure selected from a polyether structure, a polyester structure, and a polycarbonate structure.

14. The photocurable resin composition according to claim 1, wherein the curing agent (C) contains at least a photo-radical polymerization initiator.

15. A cured product obtained by curing the photocurable resin composition as set forth in claim 1.

16. The cured product according to claim 15, wherein the cured product has a specific amount of wear of less than 0.5 mm³·N⁻¹·km⁻¹.

17. The cured product according to claim 15, wherein the cured product has a friction coefficient of less than 1.0.

18. A method for manufacturing a three-dimensional object by stereolithography, the method comprising:
forming a layer of a photocurable resin composition, the photocurable resin composition being the photocurable resin composition as set forth in claim 1; and
irradiating the layer of the photocurable resin composition with light energy based on slice data of a fabrication model to cure the layer.

19. The method according to claim 18, further comprising heat-treating a shaped object obtained by the irradiation with light energy.

20. The method according to claim 18, wherein the light energy is light emitted from a laser light source or a projector.
